(19) United States
(12) Patent Application Publication
(10) Pub. No.: US 2005/0214584 A1
(43) Pub. Date: Sep. 29, 2005

(54) Magnetic recording medium, its production method, and magnetic recorder

(76) Inventors: Migaku Takahashi, Sendai-shi (JP); David Djayaprawira, Sendai-shi (JP); Hiroki Domon, Sendai-shi (JP); Satoru Yoshimura, Sendai-shi (JP)

Correspondence Address: YOUNG & THOMPSON, 745 SOUTH 23RD STREET, 2ND FLOOR, ARLINGTON, VA, 22202, US

(21) Appl. No.: 10/509,616

(22) PCT Filed: Mar. 20, 2003
(86) PCT No.: PCT/JP03/03440

§ 371 Date: May 25, 2005

(30) Foreign Application Priority Data
Mar. 29, 2002 (JP) 2002-096582

(51) Int. Cl. B05D 5/12; G11B 5/64

(52) U.S. Cl. 428/828; 427/128

(57) ABSTRACT

A method for producing a magnetic recording medium having a flat surface and a strong exchange bias field, and excellent in thermal stability. The method for producing a magnetic recording medium related to the present invention comprising a nonmagnetic substrate 1, a metal underlayer 2, and a ferromagnetic metal layer 3 formed successively in multilayer. The method comprises a step of forming the ferromagnetic layer 3 where ferromagnetic films 3a, 3b and one or more nonmagnetic metal spacer layer 4 are alternately formed in a multilayer and a step of allowing at least the interface of the nonmagnetic metal spacer layers 4 to physically adsorb oxygen and/or nitrogen.

### TECHNICAL FIELD

The present invention relates to a magnetic recording medium, the method of producing the same and a magnetic recording apparatus, and more specifically a synthetic ferrimagnetic coupled medium having a high exchange bias field, the method of producing the same, and a magnetic recording apparatus having this magnetic recording medium. The magnetic recording medium related to the present invention is preferably used for hard disks, magnetic tapes and the like.

### BACKGROUND ART

In recent years magnetic recording media are widely used in hard disk drives and the like as a high density and large capacity recording medium. However, in order to achieve a higher density, balanced improvements in its recording and reproducing characteristics and reduction of its time series changes in magnetization are sought after.

FIGS. 11 and 12 are schematic views of a hard disk constituting an example of the magnetic recording medium.

FIG. 11 is a perspective view of a discoidal magnetic recording medium, and FIG. 12 is a schematic cross sectional view along the line A-A shown in FIG. 11.

The magnetic recording medium 90 shown in FIG. 11 comprises a substrate 91 composed of a discoidal nonmagnetic substance as shown in FIG. 12, a metal underlayer 93, a ferromagnetic metal layer 95 and a protective layer 96 formed on this substrate 91.

In this example of the magnetic recording medium 90, the substrate 91 composed of a nonmagnetic subsistence comprises a non magnetic layer 93 of magnetic films composed of Ni—P on the surface of a base substrate 92 made of for example an Al alloy or glass. And on this substrate 91, the metal underlayer 94 composed of for example Cr, the ferromagnetic metal layer 95 composed of CoCrTa or CoCrTaPt, and the protective layer 96 composed of carbon or the like are formed successively in multilayer. The typical thickness of each layer is 5 μm-15 μm for the nonmagnetic (Ni—P) layer 93, 50 nm-150 nm for the metal (Cr) underlayer 94, 30 nm-100 nm for the ferromagnetic metal layer 95, and 20 nm-50 nm for the protective layer 96. It should be noted furthermore that the protective layer 96 is sometimes coated with a fluoric lubricant such as perfluoropolyether although this is not shown.

The inventors of the present invention reported that, in order to improve the recording and reproducing characteristics of the magnetic recording medium of the structure described above, it is indispensable to reduce the interaction among magnetic crystal grains composing the magnetic film that functions as the ferromagnetic metal layer 95, and to reduce the thickness of the magnetic film. (M. Takahashi, A. Kikuchi and S. Kawakita: IEEE Trans. On Magn., 33, 2938 (1997)).

The literature reveals that the reduction of the magnetic crystal grains composing the magnetic film to a infinitesimally small size by reducing the thickness of the ferromagnetic metal layer 95 is an effective method of reducing the medium noises.

There is a limit to the formation of infinitesimal structure or the reduction of the volume of magnetic grains by reducing the thickness of the magnetic film constituting the ferromagnetic metal layer 95. This is because a new problem props up in that, as the thickness of the film constituting the ferromagnetic metal layer 95 is reduced, the crystal grains composing the magnetic film become infinitesimal and the magnetization (residual magnetization) and other magnetic characteristics recorded on the magnetic film change substantially as time passes, in other words a problem of becoming easily subject to the influence of thermal decay.

Therefore, in order to suppress the thermal decay of the magnetic recording medium, a so-called “synthetic ferrimagnetic coupled medium” was invented, wherein a nonmagnetic metal intermediate layer (Ru) approximately 0.7 nm thick is inserted between two or more ferromagnetic metal layers so that the magnetization of the most closely adjoining ferromagnetic layers becomes antiparallel in residual magnetization. (E. N. Abarrra, A. Inomata, H. Sato, I. Okamoto, and Y. Mizoshita: Appl. Phys. Lett., 77, 2581 (2000))

The literature reveals that, in such a synthetic ferrimagnetic coupled medium, the possibility of suppressing time series changes in magnetic recording medium due to the development of a exchange bias field as a result of the insertion of a nonmagnetic spacer layer between the ferromagnetic layers is an effective method.

However, it is considered likely that the patterns of magnetization recorded on magnetic recording media would become still smaller as the recording density becomes higher, and in order to cope with such a development, further improvements of exchange bias field are sought after.

Therefore, one of the objects of the present invention is to provide the method of producing a magnetic recording medium having a flat surface, a high exchange bias field and an excellent thermal stability.

Another object of the present invention is to provide a magnetic recording medium having the excellent characteristics.

Another object of the present invention is to provide a magnetic recording apparatus provided with a magnetic recording medium having the excellent characteristics.

### DISCLOSURE OF INVENTION

In order to solve the above-mentioned problems, the method of producing the magnetic recording medium related to the present invention is a method of producing a magnetic recording medium that includes a step of forming the nonmagnetic substrate, a step of forming the metal underlayer on the nonmagnetic substrate and a step of forming the ferromagnetic metal layer on the metal underlayer, the step of forming the ferromagnetic metal layer consisting of a step of forming a plurality of ferromagnetic films and one or more nonmagnetic metal spacer layer or layers alternately and a step of allowing at least the interface of the nonmagnetic metal spacer layers to adsorb physically oxygen and/or nitrogen.

According to the production method, it is possible to enhance the exchange bias field of the synthetic ferrimagnetic coupled medium wherein the ferromagnetic metal layer is divided into a plurality of ferromagnetic layers by a nonmagnetic metal spacer layer or layers and to produce easily magnetic recording media excellent in thermal stability.

According to the production method, it is possible to form the nonmagnetic metal spacer layer in such a way that said oxygen and/or nitrogen may be included in the nonmagnetic metal spacer film.

And the method of producing the magnetic recording medium related to the present invention is characterized in that the gas used for forming the nonmagnetic metal spacer layer is a mixed gas obtained by mixing Ar or other rare gases with oxygen or nitrogen.

According to the production method, it is possible to allow the interface between the nonmagnetic metal spacer layer and the ferromagnetic film to easily adsorb physically oxygen and/or nitrogen, to control precisely the amount adsorbed thereof and thus produce with a high stability the magnetic recording medium having an excellent thermal stability.

And the method of producing the magnetic recording medium related to the present invention wherein the partial pressure of oxygen or nitrogen contained in said mixed gas is in a range of 10⁻⁷ Torr or above and 10⁻³ Torr or below.

By maintaining the partial pressure of oxygen or nitrogen in the mixed gas in said range, it is possible to produce magnetic recording media having an excellent thermal stability and also an excellent magnetic characteristic. When the partial pressure is below 10⁻⁷ Torr (=133×10⁻⁷ Pa), Hₑₓ tends to become small. And on the contrary when it exceeds 10⁻³ Torr (=133×10⁻³ Pa), coercive force H_{c} tends to decline. In view of these, the above-mentioned range of partial pressure has been set as a range compatible both with the high Hₑₓ and the high H_{c}.

And in the production method, it is preferable to set the partial pressure of oxygen or nitrogen contained in the mixed gas at 3×10⁻⁶ Torr or above and 3×10⁻⁵ Torr or below. By setting such partial pressure of oxygen, it is possible to obtain a high exchange bias field Hₑₓ of 1500 Oe or above and obtain an excellent thermal stability.

And then, in the method of producing magnetic recording media related to the present invention, the step of allowing at least the interface of the nonmagnetic metal spacer layer to adsorb physically oxygen and/or nitrogen is a step of exposing the surface of said nonmagnetic metal spacer layer to the atmosphere containing oxygen and/or nitrogen.

According to the production method, it is possible to allow the interface between the nonmagnetic metal spacer layer and the ferromagnetic film to adsorb physically easily oxygen and/or nitrogen.

And in the method of producing the magnetic recording medium related to the present invention, it is preferable that the exposure of the nonmagnetic metal spacer layer surface to oxygen be set at 10 Langmuir or above.

By setting the exposure of the surface of the nonmagnetic metal spacer layer to oxygen within the range described above, it is possible to produce magnetic recording media having an excellent thermal stability. If this exposure to oxygen is less than 10 Langmuir, the effect of improving thermal stability cannot be obtained.

And in the method of producing magnetic recording media related to the present invention, it is preferable to form a metal film containing one or more element or elements chosen from Ru, Ir, Cu, and Os as the above-mentioned nonmagnetic metal spacer layer.

By using an alloy containing above-mentioned elements to form the nonmagnetic metal spacer layer, it is possible to increase the exchange bias field of the ferromagnetic film and to improve substantially the thermal stability of the medium.

And then in the method of producing magnetic recording media related to the present invention, it is preferable to set the thickness of the above-mentioned nonmagnetic metal spacer layer at 0.5 nm or above and 1.0 nm or below.

Then, in order to solve the above problem, the present invention provides a magnetic recording medium having a nonmagnetic substrate, a metal underlayer, and a ferromagnetic metal layer formed successively in a multilayer, wherein the ferromagnetic metal layer includes a plurality of ferromagnetic film and one or more nonmagnetic metal spacer layer or layers formed between the ferromagnetic layers and the exchange bias field Hₑₓ of the ferromagnetic metal layer is set at 1,000 Oe or above.

According to the structure, it is possible to realize a magnetic recording medium excellent in thermal stability due to a high exchange bias field Hₑₓ that works between the ferromagnetic films separated by the nonmagnetic metal spacer layer or layers.

Furthermore, the magnetic recording medium related to the present invention can be adjusted to have an exchange bias field Hₑₓ of 1,500 Oe or above and thus provide a magnetic recording medium excellent in thermal stability.

The magnetic recording medium related to the present invention is a magnetic recording medium having the nonmagnetic substrate, the metal underlayer and the ferromagnetic metal layer formed successively in a multilayer, wherein the ferromagnetic metal layer comprises a plurality of ferromagnetic films and one or more nonmagnetic metal spacer layer or layers formed between the ferromagnetic films, the nonmagnetic metal spacer layer or layers is or are composed of one kind or more of elements chosen from Ru, Ir, Cu, and Os, and oxygen and/or nitrogen is physically adsorbed at least by the interface between the nonmagnetic spacer layer and the ferromagnetic film.

And in the magnetic recording medium related to the present invention, it is preferable that the film thickness of the nonmagnetic metal spacer layer be 0.5 nm or above and 1.0 nm or below.

The magnetic recording apparatus related to the present invention has the above-mentioned magnetic recording medium, a driving part for driving the magnetic recording medium, and a magnetic head for recording and reproducing magnetic information, wherein the magnetic head records and reproduces magnetic information on and from the moving magnetic recording medium.

According to the magnetic recording apparatus of the above construction, it is possible to provide a magnetic recording apparatus having an excellent reliability and the magnetic characteristic of which does not deteriorate even when it is used for long hours in a heated condition due to a spindle rotating at a high speed or the heating of control chips.

### BRIEF DESCRIPTION OF DRAWINGS

FIG. 1 is a cross sectional view of a magnetic recording medium constituting a mode of carrying out the present invention.

FIG. 2 is a cross sectional view of another example of composing the magnetic recording medium of the present invention.

FIG. 3 is a graph showing an example of the magnetization curve of the magnetic recording medium related to the present invention.

FIG. 4 is a descriptive graph describing the method of inducing the exchange bias field Hₑₓ.

FIG. 5 is a descriptive illustration showing an enlarged view of the ferromagnetic metal film of the magnetic recording medium of the present mode of carrying out.

FIG. 6 is graph showing the impact of the average crystal grain diameter L and the interface roughness h shown in FIG. 5 on ferromagnetic interaction Jf.

FIG. 7 is a graph showing the result of measurement of fluctuation field Hf in an embodiment of the present invention.

FIG. 8 is a graph showing the result of measurement of KuV/k₈T in an embodiment of the present invention.

FIG. 9 is a cross sectional view of the magnetic recording apparatus related to the present invention.

FIG. 10 is a plane view including a partial cross section of the magnetic recording apparatus shown in FIG. 9.

FIG. 11 is a perspective view showing an example of the magnetic recording medium.

FIG. 12 is a cross sectional view of the magnetic recording medium shown in FIG. 11.

### DESCRIPTION OF CODES

10, 20: Magnetic recording medium
1. Nonmagnetic substrate
2. Metal underlayer
3. Ferromagnetic metal layer
3a. The first ferromagnetic film
3b. The second ferromagnetic film
3c. The third ferromagnetic film.
4, 4a, 4b: Nonmagnetic metal spacer layer
5. Protective layer
   The Best Mode of Carrying Out the Invention

The present mode of carrying out of the present invention is described below with reference to drawings.

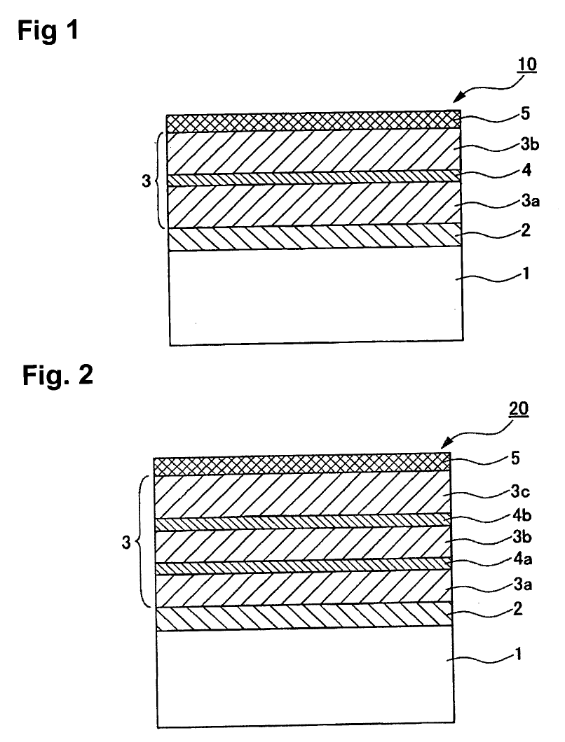

FIGS. 1 and 2 show schematically the cross section of a mode of carrying out the magnetic recording medium related to the present invention as applied to a computer hard disk, and the magnetic recording medium 10 shown in FIG. 1 includes a substrate 1 composed of a discoidal nonmagnetic substance, a metal underlayer 2 formed on the substrate 1, a ferromagnetic metal layer 3 formed on the metal underlayer 2, and a protective layer 5 formed on the ferromagnetic metal layer 3. The ferromagnetic metal layer 3 includes the first ferromagnetic film 3a formed on the metal underlayer 2, the nonmagnetic metal spacer layer 4 formed on the first ferromagnetic film 3a and the second ferromagnetic film 3b formed on the nonmagnetic metal spacer layer 4. A magnetic recording medium having this type of structure is generally called “a synthetic ferrimagnetic coupled medium”.

The layered structure of the magnetic recording medium 10 of the present mode of carrying out shown in FIG. 1 is the most basic structure of the magnetic recording medium related to the present invention, and therefore it is possible to form another intermediate layer between the substrate 1 and the first ferromagnetic film 3a whenever it is deemed necessary, or as in the case of the magnetic recording medium 20 shown in FIG. 2, it may be of a basic structure similar to the magnetic recording medium 10 shown in FIG. 1 wherein the ferromagnetic metal layer 3 includes the first ferromagnetic film 3a, the nonmagnetic metal spacer layer 4a formed on the first ferromagnetic film 3a, the second ferromagnetic film 3b form on the nonmagnetic metal spacer layer 4a, the nonmagnetic metal spacer layer 4b form on the second ferromagnetic film 3b, and the third ferromagnetic film 3c formed on the nonmagnetic metal spacer layer 4b. In other words, the ferromagnetic metal layer 3 may include a plurality of ferromagnetic films and a plurality of nonmagnetic metal spacer layers laminated alternately one on the other, and there is no structural restrictions on the number of layers thus formed.

And the protective layer 5 may obviously be coated with a lubrication layer consisting of a fluoric lubricant.

And now, the magnetic recording medium 10 having the basic structure related to the present invention will be described below in more details with reference to FIG. 1.

(Substrate)

As the substrate 1 related to the present invention, for example, base substrate consisting of aluminum and its alloys or oxides, titanium and its alloys or oxides, or silicone, glass, carbon, ceramic, plastic, resin and its compounds the surface of which is coated with a nonmagnetic layer of heterogeneous materials by the sputtering, deposition, metal plating and other film forming methods may be mentioned. In this case, it is preferable that the nonmagnetic layer formed on the surface of the substrate 1 do not magnetize at high temperature, be conductor, machineable, and yet retain a certain surface hardness. A preferable film composed of nonmagnetic materials satisfying these requirements is especially a Ni—P film made by the metal plating method.

The shape of the substrate 1 used for disks is doughnut discoidal. The substrate on which a ferromagnetic metal layer or other layers described below are formed, in other words the magnetic recording medium is rotated for example at a speed of 3,600 rpm-15,000 rpm around the center of the disk as its axis at the time of recording and reproduction. At this time, a magnetic head runs flying at a height of approximately 0.1 μm, or several tens nm above the surface or back of the magnetic recording medium. And lately a magnetic head that runs flying at a lower flying height of 10 nm or below has been developed.

Therefore, it is preferable that the substrate 1 be made in such a way that the flatness of its surface and the back, the parallelism of the surface and the back, the circumferential swell of the substrate and the roughness of both the surface and the back are properly controlled.

And when the substrate starts rotating and stops, the surface of the magnetic recording medium and that of the magnetic head come into contact and slide (Contact Start Stop: CSS). As a countermeasure for this, an almost concentric slight texture is sometimes formed on the surface of the substrate by grinding using a slurry or a tape containing diamond or alumina abrasive grains to prevent any adsorption when the magnetic head enters into contact.

With regards to the texture described above, like the conventional structure shown in FIG. 12, generally an abrasive tape is lead to slide on the upper surface of the Ni—P nonmagnetic layer 93 to form a texture in the V-shaped groove. Therefore, in the structure of the present mode of carrying out, textures may be formed on the surface of the nonmagnetic layer 1b composed of Ni—P and the like. And in place of the texture designed to improvement the sliding characteristics of the magnetic head, textures processed by laser, discrete rugged film texture formed by sputtering, rugged-type texture formed by etching the protective film and the like are known. And it is obviously possible to adopt these structures and to form rugged structures of desired shapes on the upper surface of the nonmagnetic layer 1b. Furthermore, lately a system of loading/unloading a magnetic head on a magnetic recording medium which keeps the magnetic head waiting outside of the magnetic recording medium during the standstill of the magnetic recording medium has been developed. The adoption of such a system makes it possible to adopt a structure that omits texture depending on the circumstances.

And the texture mentioned above plays a particularly important role among the systems of recording magnetic information in the in-plane direction of the ferromagnetic metal layer, and the formation of almost concentric textures on the surface of the substrate 1 can produce changes in the orientation plane of the metal underlayer 2 formed on substrate 1, and as a result can orient the crystal grains of the ferromagnetic metal layer 3 formed on the metal underlayer 2 in the circumferential direction of the substrate.

The control of orientation of magnetic crystal grains by this texture processing seriously affects the magnetic characteristic and the recording and reproducing characteristics of the magnetic recording medium during recording and reproduction, it is preferable that the textures for the purpose of controlling the orientation of magnetic crystal gains would be formed by controlling suitably the density of grooves and the uniformity of depth of grooves formed.

(Metal Underlayer)

The metal underlayer 2 of the magnetic recording medium 10 of the present mode of carrying out has a multilayer structure resulting from the successive formation of various elements thereof by the sputtering method or the deposition method. By controlling the grating coefficient of this metal underlayer 2, it is possible to improve the coercive force of the ferromagnetic metal layer 3 formed on the metal underlayer 2. And the metal underlayer 2 may consist of two, three or more layers of underlying films formed in a multilayer.

It is preferable to use Cr and Cr alloys in the metal underlayer 2. When alloys are chosen, the combination with, for example, Mo, W, Ti, V, Nb, Ta, etc. are used, and in particular it is preferable to use the CrMo alloy, and CrW alloy.

The use of Cr or Cr alloys in the metal underlayer 2 can cause the ferromagnetic metal layer 3 formed on the metal underlayer 2 to segregate. A high Cr concentration phase resulting from this segregation effect in the crystal grain boundary of the ferromagnetic metal layer 3 can suppress magnetic interactions among crystal grains of the ferromagnetic metal layer 3 and therefore enhance the standardizing coercive force of the medium. This also can cause the easy axis (c axis) of the ferromagnetic metal layer 3 on the metal underlayer 2 take the in-plane direction of the substrate. In other words, this can accelerate the growth of crystals of the ferromagnetic metal layer 3 in the direction of enhancing the coercive force in the in-plane direction of the substrate.

When a glass base substrate is used as the substrate 1, it is preferable to form a seed layer composed of Ni—Al, Ni—Nb or the like between the metal underlayer 2 and the substrate 1. The adoption of such a structure will make the crystal grains of the metal underlayer and the ferromagnetic metal layer 3 infinitesimal, and therefore it will be possible to raise the coercive force of the magnetic recording medium and at the same time it will be possible to improve its noise characteristic during recording and reproduction.

When the metal underlayer 2 composed of Cr or Cr alloys is formed by the sputtering method, as factors controlling its crystallinity, the surface form and state of the substrate (whether there is any texture or not and the like), surface condition, surface temperature, pressure at the time of forming film, bias impressed on the substrate and the thickness of film to be formed may be mentioned.

The coercive force of the ferromagnetic metal layer 3 described below tends to be stronger proportionately to the thickness of the Cr film or the Cr alloy film constituting the metal underlayer, and any increase in film thickness tends to be accompanied by a corresponding increase in roughness of the surface of the film formed. However, in order to improve the recording density of the magnetic recording medium, the flying height of the magnetic head from the surface of the magnetic recording medium is sought to be minimized to the maximum extent possible. Therefore, it is preferable that the metal underlayer 2 be formed by using a material that would provide a strong coercive force even if the metal underlayer 2 is thin.

(Ferromagnetic Metal Layer)

The ferromagnetic films 3a and 3b composing the ferromagnetic metal layer 3 used in the present invention are made of ferromagnetic metal materials having a hcp structure. The film thickness of these ferromagnetic films 3a and 3b must be adjusted to be conform to the following formula.
Bᵣtₜ=Bᵣt_{b}−Bᵣtₐ
wherein Bᵣtₜ represents the residual flux density of the total medium (desired), Bᵣt_{b} represents the residual flux density of the ferromagnetic metal layer 3b, and Bᵣtₐ represents the residual flux density of the ferromagnetic metal layer 3a. And Bᵣtₜ is generally determined by the recording and reproducing capacity of the magnetic head used in combination with the magnetic recording medium.

As materials composing the ferromagnetic metal layers 3a and 3b, it is preferable to use Co ferromagnetic alloys principally composed of Co. As specific materials, for example, CoNiCr, CoCrTa, CoPt, CoCrPt, CoNiPt, CoNiCrTa, CoCrPtTa and the like may be mentioned. It is also possible to use alloys made by adding one, two or more kinds of elements chosen from B, N, O, Nb, Zr, Cu, Ge, Si, and the like to these alloys. Furthermore, a Co film 1 nm thick may be formed on the ferromagnetic metal layer 3a or below the ferromagnetic metal layer 3b.

(Nonmagnetic Metal Spacer Layer)

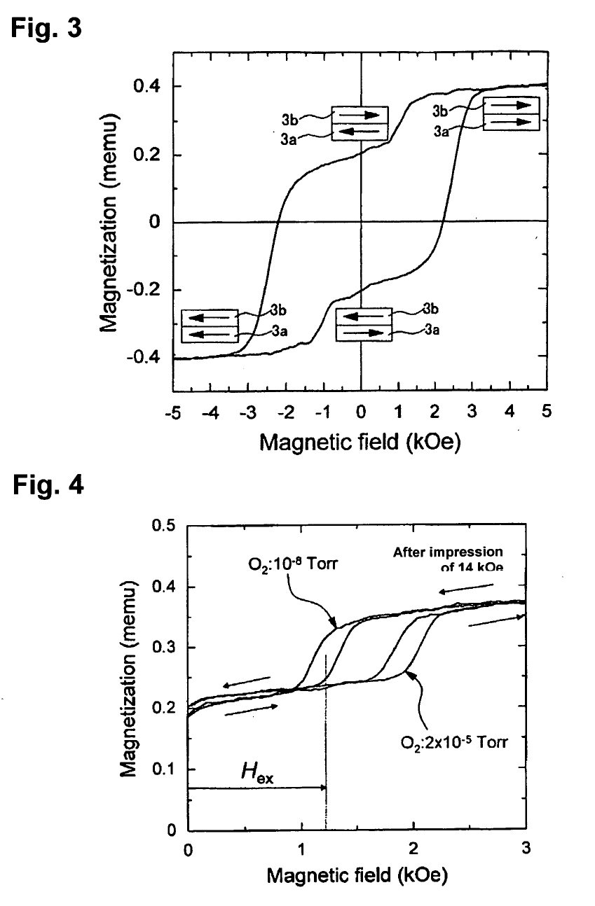

FIG. 3 is a graph showing an example of magnetization curves of the magnetic recording medium related to the present invention, and FIG. 4 is a descriptive graph describing the method of introducing the exchange bias field Hₑₓ in the magnetic recording medium 10 related to the present invention. In a synthetic ferrimagnetic coupled medium, wherein a nonmagnetic metal spacer layer 4 is sandwiched between a ferromagnetic film 3a and another ferromagnetic film 3b shown in FIG. 1, RKKY exchange interactions Jₑₓ develop between them, and the presence of this Jₑₓ creates an internal magnetic field in the ferromagnetic film 3a. This internal magnetic field is oriented in the reverse direction of that of magnetization of the ferromagnetic film 3b. Accordingly, the coercive force of the ferromagnetic film 3a is smaller than the internal magnetic field, and in the absence of external magnetic field, the magnetization orientation of the ferromagnetic films 3a and 3b becomes antiparallel. Therefore, when the external magnetic field is sufficiently strong (both sides of the graph of FIG. 3), the magnetization orientation of the ferromagnetic films 3a, 3b both remains identical with those of the external magnetic field. When the external magnetic field is nil, however, the magnetization orientation of the ferromagnetic film 3a and that of the ferromagnetic film 3b are reverse.

Here, the internal magnetic field that develops in the ferromagnetic film 3a shall be called “exchange bias field Hₑₓ.” As shown in FIG. 4, this exchange bias field Hₑₓ, can be introduced as an amount of shift of the magnetization curve of the ferromagnetic film 3a from the original point when the medium is saturated in one direction, the magnetic field is removed, and then a magnetic field is impressed in the reverse direction. In the magnetic recording medium related to the present invention, it is preferable that the exchange bias field Hₑₓ which is an internal magnetic field that develops in the ferromagnetic film 3a would be set at 1,000 (Oe) or above. By setting in such a range, it is possible to improve thermal stability in a medium having a coercive force of 2,000-4,000 Oe and to produce a magnetic recording medium having a high reliability. To be more specific, it is possible to realize a KuV/k_{B}T of 80-90 or above in a medium having the coercive force mentioned above. And when the exchange bias field Hₑₓ is set at 1,500 Oe or above, a KuV/k_{B}T of 100 or above can be realized. Although the ceiling for this exchange bias field Hₑₓ is not specifically specified, it is difficult to obtain a exchange bias field of more than 2,500 Oe in a magnetic recording medium having the coercive force as mentioned above.

As the material composing the nonmagnetic metal spacer layer 4, it is preferable to choose an alloy containing one or more elements chosen from Ru, Ir, Cu, and Os. It is possible to improve the exchange bias field Hₑₓ by choosing these materials for the nonmagnetic metal spacer layer 4.

And the nonmagnetic metal spacer layer 4 related to the present invention has oxygen and/or nitrogen physically adsorbed at least at its interface. By allowing these gases to be adsorbed, the magnetic recording medium 10 related to the present invention can realize a stronger exchange bias field Hₑₓ as shown in FIG. 4, and will be a better magnetic recording medium in terms of thermal stability.

It is preferable that the film thickness of the nonmagnetic metal spacer layer 4 would be in a range of 0.5 nm or above and 1.0 nm or below, because the exchange bias field Hₑₓ will be the maximum in this range.

The following is a description of the process of producing a magnetic recording medium 10 of the composition described above by the sputtering method.

(Sputtering Method)

The sputtering method which is an example of the method of producing the magnetic recording medium 10 related to the present invention include, for example, a transferring-type sputtering method wherein the thin film is formed while the substrate 1 moves before the target and a static-type sputtering method wherein the thin film is formed while the substrate 1 remains fixed before the target.

The former transferring-type sputtering method is productive and suitable for mass production, and is therefore advantageous for the production of magnetic recording media at a low cost, while the latter static-type sputtering method enables to produce magnetic recording media having an outstanding recording and reproducing characteristic because of a stable angle of incidence of the sputtering particles in relation with the substrate 1. The sputtering method used for producing the magnetic recording media 10 related with the present invention is not limited to the transferring-type and the static-type.

The magnetic recording medium 10 related with the present invention can be produced by applying the sputtering method to form successively the substrate 1, the metal underlayer 2, the ferromagnetic metal layer 3 (ferromagnetic film 3a, nonmagnetic metal spacer layer 4, ferromagnetic film 3b), and the protective layer 5 in a multilayer.

And, when a magnetic recording medium 10 is produced by the production method related to the present invention, during or after the formation of the nonmagnetic metal spacer layer 4, the substrate 1 is disposed in the atmosphere containing oxygen and/or nitrogen to allow at least at the interfaces between the nonmagnetic metal spacer layer 4 and the ferromagnetic films 3a and 3b to adsorb physically oxygen and/or nitrogen. This processing will be described in more details below.

In order to allow only the interface between the nonmagnetic metal spacer layer 4 and the second ferromagnetic film 3b to adsorb physically oxygen and/or nitrogen, after the nonmagnetic metal spacer layer 4 is formed, it is enough to expose the surface of the nonmagnetic metal spacer layer 4 in an atmosphere containing oxygen and/or nitrogen to allow the surface to adsorb a given amount of oxygen and/or nitrogen. In this exposure processing, it is possible to control the intake into the surface of the nonmagnetic metal spacer layer 4 by means of the partial pressure of oxygen and nitrogen as well as the exposure time. In case where the nonmagnetic metal spacer layer 4 is composed by the materials described above, it is preferable to set the value at 10 L (Langmuir) or more. Here, 1 L means an exposure for one second at 1×10⁻⁶ Torr, or an exposure for ten seconds at 1×10⁻⁷ Torr, and 25 L means an exposure for 25 seconds at 1×10⁻⁶ Torr or an exposure for 250 seconds at 1×10⁻⁷ Torr.

Incidentally, with regards to the partial pressure of oxygen and/or nitrogen and exposure time in the actual production, optimum values of partial pressure or exposure time may be chosen depending on the affinity with oxygen of the materials composing the nonmagnetic metal spacer layer 4. And it is possible to use a gas obtained by diluting oxygen or nitrogen by a rare gas may be used.

Or, it is possible to allow the surface of the nonmagnetic metal spacer layer 4 physically adsorb gas components consisting of oxygen and/or nitrogen by using a mixed gas obtained by adding oxygen and/or nitrogen to Ar or other rare gases as a gas for forming the nonmagnetic metal spacer layer 4. Since this method allows the nonmagnetic metal spacer layer 4 adsorb oxygen and/or nitrogen inside, an excessive addition of oxygen and/or nitrogen may cause crystallinity to deteriorate or oxides or nitrides to develop depending on the material or materials composing the nonmagnetic metal spacer layer 4. Therefore, it is preferable that the addition of oxygen or nitrogen as expressed by the partial pressure in a mixed gas with Ar or other rare gas would be kept within a range of 10⁻⁷ Torr or above and 10⁻³ Torr or below.

Further, it is preferable that the partial pressure of oxygen or nitrogen contained in the mixed gas would be set at 3×10⁻⁶ Torr or above and 3×10⁻⁵ Torr or below. By choosing such a range, it is possible to obtain a exchange bias field of 1,500 Oe or above, and to have KuV/k_{B}T of 100 or more.

As “impurities for Ar gas used for forming film” in the present invention, for example, H₂O, O₂, CO₂, H₂, N₂, CₓH_{y}, H, C, O, CO and the like are mentioned. The impurities likely to affect the amount of oxygen adsorbed into the film, in particular, are supposed to be H₂O, O₂, CO₂, O, and CO. Therefore, density of impurities of the present invention shall be expressed by the sum of H₂O, O₂, CO₂, O, and CO contained in the Ar gas used for forming the film.

And the impression of bias to the substrate 1 has an effect of intensifying the coercive force of the magnetic recording medium. This effect tends to be greater when the bias is impressed on a double-layered or multilayered layer than when it is impressed on a single layer.

(Surface Roughness of the Medium, Ra)

As the surface roughness of the substrate in the present invention, for example, the average central line roughness Ra obtained by measuring in the radial direction the surface of a discoidal substrate. As an instrument of measuring the surface roughness Ra, an atomic force microscope (AFM) may be used.

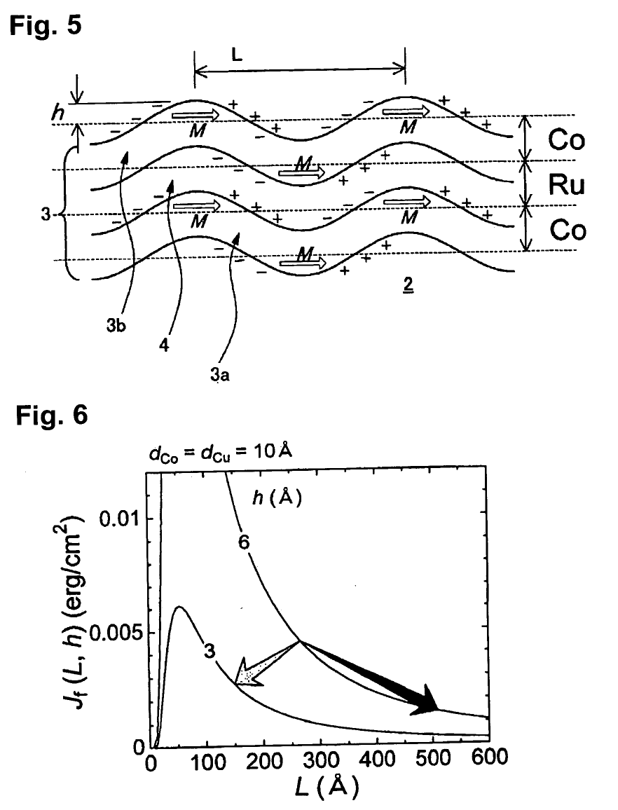

In the magnetic recording medium related to the present invention, the exchange bias field Hₑₓ, and the surface roughness Ra of the nonmagnetic metal spacer layer 4 of the medium or that of the medium are correlated. The smaller the surface roughness Ra of the nonmagnetic metal spacer layer 4 becomes, the larger the exchange bias field Hₑₓ can be. This means that, due to the development of magnetic poles in the ferromagnetic layer interface resulting from the interface roughness of the nonmagnetic metal spacer layer and explicable by Neel's model called “orange peel effect,” ferromagnetic magnetostatic coupling has developed tending to arrange magnetization in the magnetic layer in parallel (L. Neel: Comp. Rend. Acad. Sci., 255, 1545 (1962)). FIG. 5 is a descriptive illustration for explaining Neel's model and shows schematically the cross sectional structure of the ferromagnetic metal layer 3. As this figure show, the ferromagnetic metal layer 3 formed on the underlayer 2 is formed in a shape adapted to the irregular surface of the underlayer 2. And FIG. 6 shows the calculation of the ferromagnetic coupling energy Jf that works between the ferromagnetic layers by applying the model of Kools et al. that expanded the thickness of the magnetic layer to a limited thickness (J. C. S. Kools, W. Kula, D. Mauri and T. Lin: J. Appl. Phys., 85, 4466 (1999)) and by using [Formula 1]. Here, it is assumed that the film is multilayered having 29 layers, and that the ferromagnetic layer and the nonmagnetic metal spacer layer are 1 nm thick respectively. As FIG. 6 shows clearly, the magnitude of the ferromagnetic coupling energy Jf depends on the crystal grain diameter L and the interface roughness h. Therefore, if the crystal grain diameter is equal, any decrease in the interface roughness reduces the ferromagnetic coupling energy Jf between magnetic layers and increases anti-ferromagnetic coupling energy Jₑₓ between magnetic layers, and leads to an aggrandizement of the exchange bias field Hₑₓ.

$${J}_{f} ( erg \text{/} {cm}^{2} ) = 2 \frac{{π}^{2}}{\sqrt{2}} \frac{{h}^{2}}{L} {M}^{2} exp ( - 2 π \sqrt{2} \frac{{d}_{Ru}}{L} ) {( 1 - exp ( - 2 π \sqrt{2} \frac{{d}_{Co}}{L} ) )}^{2} \qquad ( Formula 1 )$$

In the (Formula 1) shown above, however, d_{Ru} and d_{Co} represent respectively the thickness of the nonmagnetic metal spacer layer 4 and the ferromagnetic film 3a (3b).

And when the substrate 1 has begun rotating from a standstill or inversely has come to a standstill from a running state, the surface of the magnetic recording medium and that of the magnetic head come into contact and slide (CSS motion). At this time, it is preferable that the surface roughness Ra would be on a greater side in order to restrict the adsorption of the magnetic head to the medium surface and any rise in friction coefficient. When the substrate has reached the maximum rotating speed, on the other hand, it is necessary to maintain the distance between the magnetic recording medium and the magnetic head, in other words the flying height of the magnetic head at the minimum value possible. And accordingly a small value for Ra is preferable. Therefore, the maximum value and the minimum value for the surface roughness Ra of the substrate 1 will be determined as required by the reason given above and the required specification for the magnetic recording medium.

For example, when the flying height of the magnetic head is 24μ inch (about 0.6 μm), Ra=6 nm-8 nm. However, in order to achieve a higher recording density, it is necessary to reduce further the flying height of the magnetic head (the distance of separation between the magnetic head and the magnetic recording medium during the recording and reproducing operation). In order to meet this requirement, it is important to make the surface of the magnetic recording medium more flat and smooth. For these reason, a smaller value is desirable for the surface roughness Ra of the substrate. Accordingly, it is enough to adopt a production method wherein various targeted film characteristics can be achieved even if the surface roughness of the substrate is smaller. For example, a texture is formed on a magnetic recording medium consisting of an Al base substrate and a Ni—P layer formed thereon and Ra is reduced to below 1.5 nm, and it is possible to achieve a Ra of 0.5 nm-0.7 nm on a NiP/Al base substrate subjected to a special grinding processing.

(Texture Processing)

As texture processing that may be applied on the substrate in the present invention, for example, mechanical abrasion method, scientific etching method, physical method of producing irregular films, and the like may be mentioned. In particular, in the case of aluminum alloy base substrates most widely used as the base substrate for the magnetic recording media, the mechanical grinding method is used.

For example, there is a method of producing slight concentric textures by pressing a tape glued with abrasive grains for grinding against the rotating surface of the substrate, specifically a (Ni—P) film formed on the surface of an aluminum alloy substrate. In this method, abrasive grains for grinding may be separated from the tape and used.

However, for reasons given in the section “Surface roughness of the substrate,” the texture processing described above may not be resorted to, or a production method wherein the targeted various film characteristics can be obtained by means of a more slight texture may be adopted depending on the situation.

### EXAMPLES

The present invention will be described below in more details with reference to test examples. However, the present invention is not limited to these test examples.

### Test Example 1

In the present test example, a magnetic recording medium provided with the nonmagnetic metal spacer layer 4 shown in FIG. 1 was produced by varying the partial pressure of the oxygen (O₂) gas used for forming the medium within a range of 10⁻⁷ Torr-10^{-4.5} Torr. The film was formed by using the DC magnetron method, and an ultra clean process wherein the ultimate vacuum in the deposition chamber was set at the level of 10⁻⁹ Torr and the concentrations of impurities in the process gas was set at 1 ppb or below. And during the processing, the substrate was kept at a temperature of 250° C. by means of a radiant heater, and after the substrate is heated, the above-mentioned metal underlayer, the ferromagnetic metal layer, the nonmagnetic spacer layer and the protective layer were formed with Ar gas set at a pressure of 2-5 m Torr. The nonmagnetic spacer layer was formed with a mixed gas consisting of Ar gas and a very small amount of oxygen (O2) gas. And no bias was impressed and no dry etching was conducted on the substrate during the forming of the metal underlayer and the ferromagnetic metal layer.

In the present test example, a discoidal Al base substrate electroplated with NiP and not subjected to texture processing the surface of which is polished ultra flat (Ra<0.3 nm) is used for the substrate, a CrMo₂₀ target is used for forming the underlying film, a Co-16 at % Cr-8 at % Pt-4 at % B target is used as targets for forming the first and the second ferromagnetic films. And a Ru target is used as the target for forming the nonmagnetic spacer layer. And the following thickness is chosen for various films: 5 nm for the underlayer, 2.5 nm for the first ferromagnetic film, 9 nm for the second ferromagnetic film, 0.8 nm for the nonmagnetic metal spacer layer and 6 nm for the protective film.

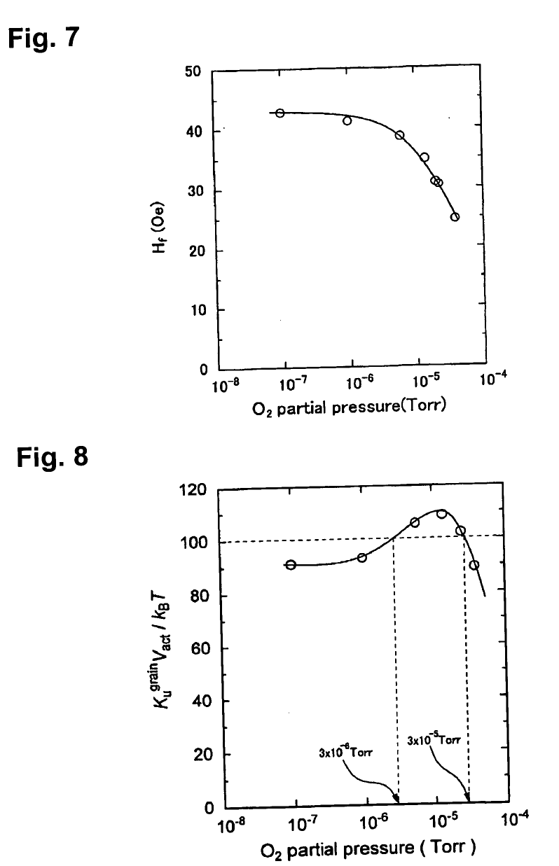

And with regard to the magnetic recording medium thus obtained, fluctuation field Hᵣ (Oe) and an index of thermal stability KuV/k_{B}T were measured. The results of the measurements are shown in FIGS. 7 and 8.

As FIGS. 7 and 8 show, all the magnetic recording media produced by the production method related to the present invention have a KuV/k_{B}T value of 80 or more indicating that they are magnetic recording media excellent in thermal stability. And the higher the partial pressure of oxygen during the forming of the nonmagnetic metal spacer layer 4, the more the fluctuation field Hf is reduced and the more KuV/k_{B}T increases. More specifically, in comparison with a sample (Hₑₓ≈1,100 Oe) with a partial pressure of oxygen set at 10⁻⁷ Torr during the forming of the nonmagnetic metal spacer layer 4, the sample (Hₑₓ≈2,000 Oe) with a partial pressure of oxygen set at 10⁻⁵ Torr, the fluctuation field is reduced by approximately 30 percent and KuV/k_{B}T increased by approximately 22 percent.

And as FIG. 7 shows, when the partial pressure of oxygen is set in a range of 3×10⁻⁶ Torr-3×10⁻⁵ Torr, a KuV/k_{B}T value of 100 or more is obtained, indicating that magnetic recording media excellent in thermal stability have been obtained. And in a range where KuV/k_{B}T of 100 or more can be obtained, Hₑₓ of the ferromagnetic film showed a high value of 1,500 Oe or above.

According to the production method related to the present invention, it is possible to produce magnetic recording media far better in thermal stability by setting the partial pressure of oxygen during the formation of the nonmagnetic metal spacer layer 4 in an adequate range.

While in the present test sample, the DC magnetron sputtering method was used for forming the metal underlayer and the ferromagnetic metal layer, the RF sputtering method, the laser deposition method, the ion beam method and other film forming methods can obviously be applied.

(Magnetic Recording Apparatus)

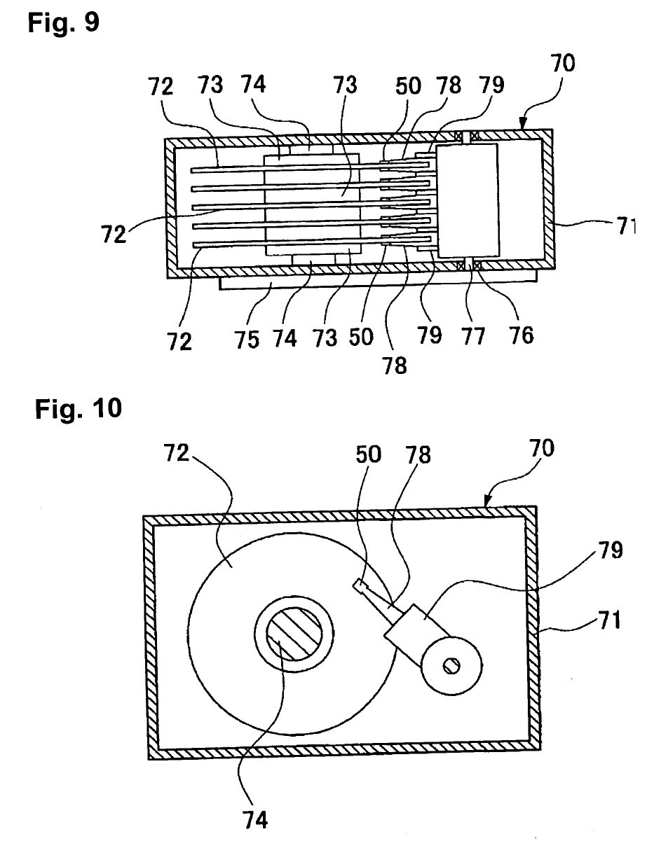

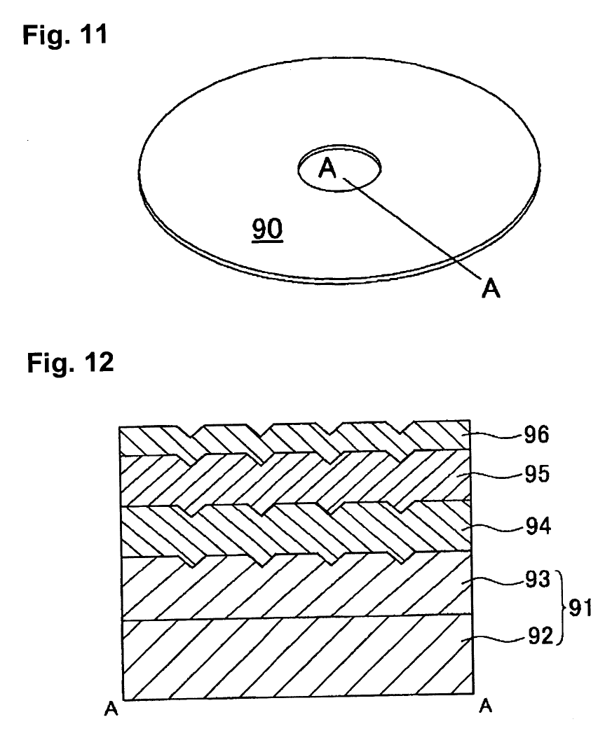

And now the magnetic recording apparatus related to the present invention will be described below with reference to drawings. FIG. 9 is a cross sectional view showing an example of a hard disk drive which is a magnetic recording apparatus related to the present invention, and FIG. 10 is a plane view of the magnetic recording layer shown in FIG. 9. In FIGS. 8 and 9, 50 represents a magnetic head, 70 is a hard disk drive, 71 is a housing, 72 is a magnetic recording medium, 73 is a spacer, 79 is a swing arm, and 78 is a suspension. The hard disk drive 70 related to the present mode of carrying out mounts the magnetic recording medium of the present invention described above.

The hard disk drive 70 is externally constituted by the rectangular housing 71 having an inner space for housing the discoidal magnetic recording medium 72, the magnetic head 50 and other elements. This housing 71 contains inside a plurality of magnetic recording media 72 skewered alternately with spacers 73 on a spindle 74. And the housing 71 contains a bearing (not shown) for the spindle 74, and on the outside of the housing 71 there is a motor 75 for rotating the spindle 74. By this structure, all the perpendicular recording media 72 are kept rotatively around the spindle 74 being bundled together plurally while leaving intervals with spacers 73 for allowing the approach of magnetic heads 50.

In the housing 71 and beside the magnetic recording medium 72, there is a rotary shaft 77 called “rotary actuator” being supported by the bearing 76 in parallel with the spindle 74. This rotary shaft 77 is provided with a plurality of swing arms 79 protruding in the space between each magnetic recording medium 72. At the tip of each swing arm 79, a magnetic head 50 is fixed through a slender triangular suspension 78 fixed diagonally opposite to the surface of each magnetic recording medium 72 located above or below the same. This magnetic head 50 is provided with a recording element not shown for writing information on the magnetic recording medium 72 and a reproduction element not shown for reading information from the magnetic recording medium 72.

It is possible according to the structure to rotate the magnetic recording medium 72, to move the magnetic head 50 in the radius direction of the magnetic recording medium 72 by the movement of the swing arm 79, and therefore the magnetic head 50 can move to any position on the magnetic recording medium 72.

The hard disk drive 70 of the structure described above can write desired magnetic information on a magnetic recording medium 72 by rotating the magnetic recording medium 72, by moving the swing arm 79 and by causing the magnetic field generated by this magnetic head 50 act on the ferromagnetic metal layer composing the magnetic recording medium 72. It also can read magnetic information by moving the swing arm 79 and the magnetic head 50 to an optional position on the magnetic recording medium 72 and by detecting the leakage magnetic field from the ferromagnetic metal layer constituting the magnetic recording medium 72 by means of the reproduction element of the magnetic head.

If, in reading and writing magnetic information as shown above, the ferromagnetic metal layer of the magnetic recording medium 72 has an excellent standardizing coercive force and thermal stability as described above, the ferromagnetic metal layer of the magnetic recording medium 72 does not deteriorate even if the inside of the hard disk drive 70, being subjected to the heat of the motor 75, is used while being heated at a high temperature, for example, in excess of 100° C. In addition, the present invention can provide a hard disk drive 70 that does not cause the recording and reproducing characteristics of the magnetic recording medium 72 even if it is used for long hours and is heated for long hours.

Incidentally, the hard disk drive 70 described above with reference to FIGS. 9 and 10 show only an example of magnetic recording apparatuses, and the number of magnetic recording media mounted on the magnetic recording apparatus may be any optional number of one or more, and the number of magnetic heads mounted may be any optional number of one or more. And the shape and the driving system of the swing arm 79 are not limited to those shown on the figure, and the linear driving system and any other systems may obviously be adopted.

### INDUSTRIAL APPLICABILITY

As described in details above, according to the present invention, it is possible to obtain a magnetic recording medium having a high recording and reproducing characteristic, S/N ratio and excellent in thermal stability by improving Hₑₓ of the magnetic recording medium.

And the present invention can provide a magnetic recording apparatus that causes no deterioration in its magnetic characteristics even if it is used for long hours in a heated condition provided that it is a magnetic recording apparatus provided with a magnetic recording medium excellent in magnetic characteristics. Moreover, the present invention can provide a magnetic recording apparatus with a high S/N ratio and excellent recording and reproducing characteristics, provided that it is a magnetic recording apparatus provided with a magnetic recording medium excellent in magnetic characteristics.

1. A method of producing a magnetic recording medium comprising a step of forming successively a nonmagnetic substrate, a metal underlayer and a ferromagnetic metal layer in a multilayer wherein
the step of forming said ferromagnetic metal layer is a step of forming alternately a plurality of ferromagnetic films and one or more nonmagnetic metal spacer layer or layers in a multilayer, and comprising
a step of allowing at least the interface of said nonmagnetic metal spacer layer or layers to adsorb physically oxygen and/or nitrogen.

2. The method of producing the magnetic recording medium according to claim 1 wherein said nonmagnetic metal spacer layer or layers is or are formed in such a way that said oxygen and/or nitrogen may be contained in the film of the nonmagnetic metal spacer layer or layers.

3. The method of producing the magnetic recording medium according to claim 1 wherein the gas used for forming said nonmagnetic metal spacer layer or layers is a mixed gas obtained by mixing oxygen or nitrogen with Ar or other rare gases.

4. The method of producing the magnetic recording medium according to claim 3 wherein the partial pressure of oxygen or nitrogen contained in such mixed gas is set at 10⁻⁷ Torr or above and 10⁻³ Torr or below.

5. The method of producing the magnetic recording medium according to claim 4 wherein the partial pressure of oxygen or nitrogen contained in such mixed gas is set at 3×10⁻⁶ Torr or above and 3×10⁻⁵ Torr or below.

6. The method of producing the magnetic recording medium according to claim 1 wherein the step of allowing at least the interface of said nonmagnetic metal spacer layer or layers to adsorb physically oxygen and or nitrogen is a step of exposing the surface of said nonmagnetic metal spacer layer or layers to an atmosphere containing oxygen and/or nitrogen.

7. The method of producing the magnetic recording medium according to claim 6 wherein the exposure of the surface of said nonmagnetic metal spacer layer or layers to oxygen is set at 10 Langmuir or more.

8. The method of producing the magnetic recording medium according to claim 1 wherein a metal film containing a kind or more of element or elements chosen from Ru, Ir, Cu and Os for said nonmagnetic metal spacer layer or layers is formed.

9. The method of producing the magnetic recording medium according to claim 1 wherein the thickness of said nonmagnetic metal spacer layer or layers is set at 0.5 nm or more and 1.0 nm or below.

10. A magnetic recording medium comprising a nonmagnetic substrate, a metal underlayer and a ferromagnetic metal layer formed successively in a layer, wherein
said ferromagnetic metal layer comprises a plurality of ferromagnetic films and one or more nonmagnetic metal spacer layer or layers formed between said ferromagnetic films, and
the exchange bias field Hₑₓ of said ferromagnetic metal layer is set at 1,000 Oe or above.

11. The magnetic recording medium according to claim 10 wherein the exchange bias field Hₑₓ of said ferromagnetic metal layer is set at 1,500 Oe or above.

12. A magnetic recording medium comprising a nonmagnetic substrate, a metal underlayer and a ferromagnetic metal layer formed successively in a layer, wherein
said ferromagnetic metal layer comprises a plurality of ferromagnetic films and one or more nonmagnetic metal spacer layer or layers formed between said ferromagnetic films,
said nonmagnetic metal spacer layer or layers is or are a metal film or films containing one kind or more of element or elements chosen from Ru, Ir, Cu and Os, and
oxygen and/or nitrogen is or are physically absorbed at least at the interface between said nonmagnetic spacer layer or layers and said ferromagnetic films.

13. The magnetic recording medium according to claim 10 wherein the thickness of said nonmagnetic metal spacer layer or layers is set at 0.5 nm or above and 1.0 nm or below.

14. A magnetic recording apparatus comprising a magnetic recording medium according to claim 10, a driving part for driving said magnetic recording medium and a magnetic head for recording and reproducing magnetic information, wherein said magnetic head records and reproduces magnetic information on and from said moving magnetic recording medium.
